(19) United States
(12) Patent Application Publication
(10) Pub. No.: US 2026/0080263 A1
(43) Pub. Date: Mar. 19, 2026

(54) NEURAL NETWORKS WITH DISTRIBUTED PATH COMPOSITION

(71) Applicant: DeepMind Technologies Limited, London (GB)

(72) Inventors: Arthur Douillard, London (GB); Qixuan Feng, London (GB); Andrei-Alexandru Rusu, London (GB); Adhiguna Surya Kuncoro, London (GB); Yanislav Donchev, London (GB); Rachita Chhaparia, London (GB); Marc'Aurelio Ranzato, London (GB); Jiajun Shen, London (GB); Arthur David Szlam, New York, NY (US)

(21) Appl. No.: 18/885,242

(22) Filed: Sep. 13, 2024

(51) Int. Cl. G06N 3/098

(52) U.S. Cl. CPC G06N 3/098

(57) ABSTRACT

Methods, systems, and apparatus, including computer-readable media, are described for training a neural network on a training dataset using a distributed computing system that includes a plurality of workers. The neural network includes a plurality of components. Each component includes a respective subset of the plurality of parameters of the neural network.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

A general trend with neural networks has been to make larger and more complicated networks in order to achieve higher accuracy. As neural networks increase in size and complexity in service of increased accuracy, they also increase in computational and communication cost during the training of the neural networks.

### SUMMARY

This specification describes a distributed computing system that includes multiple workers in one or more locations and that implements, trains, or both a neural network to perform one or more machine learning tasks.

The subject matter described in this specification can be implemented in particular embodiments so as to realize one or more of the following advantages.

By dynamically composing different components of a neural network into different paths through the neural network for multiple machine learning tasks, the techniques described in this specification can implement a sparsely activated neural network that uses only a smaller subset of all parameters of the neural network to compute an inference for a given input for one of the tasks, and thus consumes fewer computational resources, while still having a performance that is equivalent to or better than conventional neural networks.

Implementation of the described techniques also make the training of the neural network more practical and less computationally resource intensive. Conventional approaches to training large neural networks on a distributed computing system require a large number of interconnected hardware accelerators such as GPUs or TPUs. This is in part because many existing data parallelism or model parallelism algorithms require high bandwidth communications between devices that need to exchange data with one another during the training.

In contrast, implementations of the described techniques can reduce the communication required between computing devices during the training by two or three orders of magnitude compared with such conventional approaches because synchronizing the parameter values of the respective local instances of the components across the computing devices after every inner optimization step is not needed. This in turn enables a much more distributed and flexible approach—for example the computing devices can be heterogeneous, physically spaced apart from one another, and connected by a communication network with a poor or a non-ideal condition. With the described techniques computing devices on which the components of the neural network are implemented need not be manufactured by the same hardware manufacturer, and can be located in different countries, or even different continents.

Implementations of the described techniques can further facilitate the training of larger-scale neural networks to achieve higher performance on any of a range of machine learning tasks. By allowing for auto-scaling the size of the pool of workers according to resource availability, implementations of the described techniques can achieve elastic resource utilization and mitigate resource overcapacity issues, thereby improving efficiency in use of computational resources by the training process—for example can train a large neural network having 1 billion or more parameters faster (e.g., in wall-clock time) and while consuming fewer computational resources (e.g., memory and processing power) than conventional techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example distributed computing system.

FIG. 1B shows examples of selecting paths through an example neural network using a router.

FIG. 1C shows an example path through an example neural network.

FIG. 1D shows example workers included in a distributed computing system.

FIG. 2 is a flow diagram of an example process for training a neural network.

FIG. 3 is a flow diagram of sub-steps of one of the steps of the process of FIG. 2.

FIG. 4 is a flow diagram of sub-steps of another one of the steps of the process of FIG. 2.

FIG. 5 is a flow diagram of an example process for using a neural network to generate a network output from a network input.

Like reference numbers and designations in the various drawings indicate like elements.

### DETAILED DESCRIPTION

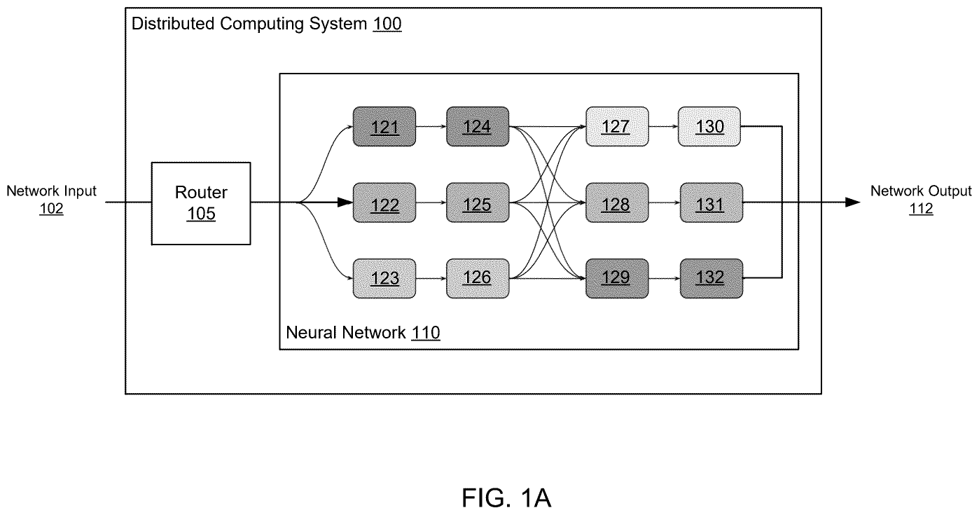

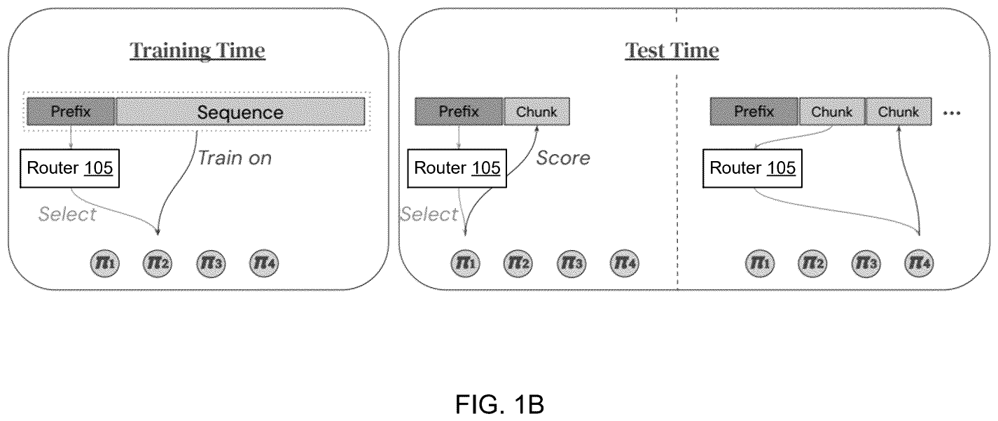

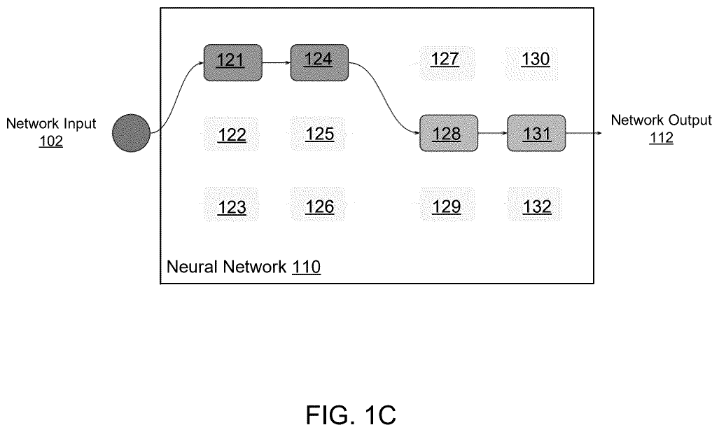

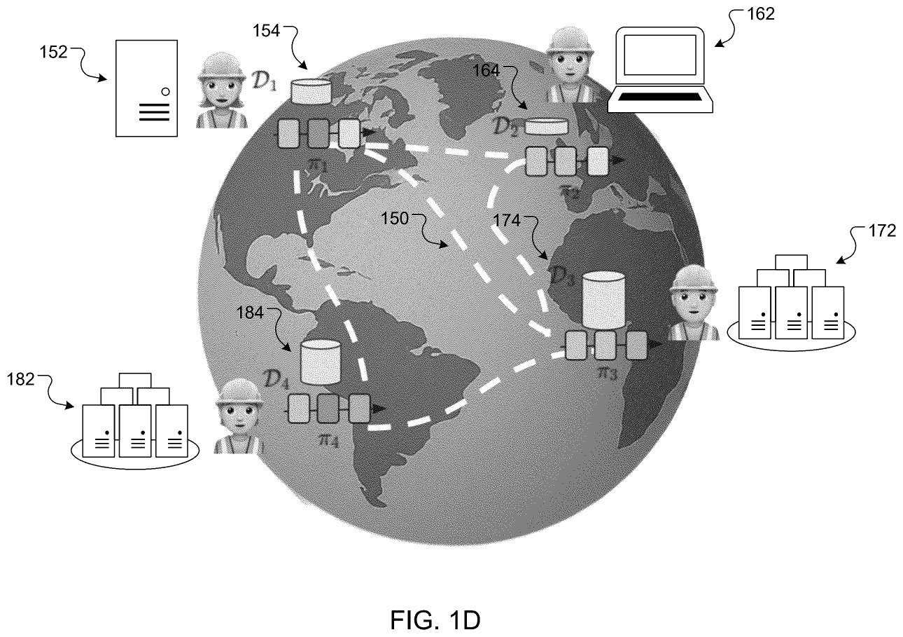

FIG. 1A shows an example distributed computing system 100 that implements, trains, or both a neural network 110 to perform one or more machine learning tasks. The distributed computing system 100 includes multiple workers in one or more locations.

The neural network 110 can perform any kind of machine learning task, i.e., the neural network 110 can be configured through training to receive any kind of network input 102 and to generate a network output 112 that includes any kind of score, classification, or regression (e.g., generative) output based on the network input.

In some situations, the neural network 110 can be referred to as an auto-regressive neural network when the neural network auto-regressively generates an output sequence of tokens as the network output. More specifically, the auto-regressively generated output is created by generating each particular token in the output sequence conditioned on a current input sequence that includes an input sequence included in the network input 102 and any tokens that precede the particular token in the output sequence, i.e., the tokens that have already been generated for any previous positions in the output sequence that precede the particular position of the particular token.

As a particular example, the neural network 110 can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. L e. Towards a human-like open-domain chatbot. CoRR, abs/2001.09977, 2020; Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020; Aakanksha Chowdhery, et al. PaLM: Scaling Language Modeling with Pathways, arXiv preprint arXiv: 2204.02311; Rohan Anil, et al. Palm 2 technical report. arXiv preprint arXiv: 2305.10403, 2023; and Gemini Team, et al. Gemini: a family of highly capable multimodal models. arXiv preprint arXiv: 2312.11805 (2023).

For example, the neural network 110 may be a (generative) language mode neural network. Examples of generative language model neural networks include Sparrow (Glaese et al. arXiv: 2209.14375), Chinchilla (Hoffmann et al. arXiv: 2203.15556), and PaLM 2 (Anil, et al. arXiv: 2305:10403).

As another example, the neural network 110 may be a multi-modal model neural network, e.g., a vision language model (VLM) neural network. Examples of multi-modal neural networks include Flamingo (Alayrac et al. arXiv: 2204.14198), PaLI (Chen et al. arXiv: 2209.06794), and PaLI-X (Chen et al. arXiv: 2305.18565).

As another example, the neural network 110 may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia et al. arXiv: 2205.11487) and Parti (Yu et al. arXiv: 2206.10789).

To enable the performance of multiple machine learning tasks, the neural network 110 includes a plurality of “components.” Each component may be viewed as a modular neural network component that is a distinct module of the neural network. Each component thus may alternatively be referred to as a “module” or an “expert.”

While FIG. 1A illustrates that the neural network 110 includes only twelve components 121-132, in general, the neural network 110 can include a larger number of components, e.g., the neural network 110 can include hundreds of components when it is configured as a generative (large) language model (LLM) or a multi-modal model having one of the architectures described above.

The neural network 110 includes a plurality of parameters. The neural network 110 includes multiple layers connected in any appropriate configuration (e.g., as a directed graph of layers). The plurality of parameters include, for each of the multiple layers of the neural network 110, parameters that represent the weights and, in some cases, the biases of the layer.

The type and the number of layers included in the neural network 110 will be dependent on the tasks for which the neural network 110 is to be used. Generally, however, the layers of the neural network 110 can include convolutional layers, fully-connected layers, recurrent layers, attention layers (e.g., self-attention layers or cross-attention layers), embedding layers, activation layers (e.g., non-linear activation layers), to name just a few examples.

Each component, in turn, includes a respective, non-overlapping subset of the plurality of parameters of the neural network 110. Each component is configured to receive a respective component input and to process the respective component input in accordance with the respective subset of the plurality of parameters of the neural network 110 to generate a respective component output. The respective component input can be either a part of the network input 102, or a respective component output generated by another component.

For example, in FIG. 1A, component 121 is configured to receive, as a component input, a portion of the network input 102 and to process the component input in accordance with a subset of the plurality of parameters of the neural network 110 included in the component 121 to generate a component output. As another example, in FIG. 1A, component 124 is configured to receive, as a component input, the component output generated by the component 121 and to process the component input in accordance with a subset of the plurality of parameters of the neural network 110 included in the component 124 to generate a component output.

In some cases, each of the multiple components of the neural network 110 corresponds to a different one of the multiple layers of the neural network 110. That is, each layer is a component of the neural network 110. For example, in FIG. 1A, component 121 is a first layer of the neural network 110, while component 122 is a second layer of the neural network 110.

In some other cases, each of the multiple layers of the neural network 110 includes multiple components. That is, each component includes a subset of the parameters of a layer of the neural network 110. For example, in FIG. 1A, a first layer of the neural network 110 can include components 121, 122, 123 while a second layer of the neural network 110 can include components 124, 125, 126. As a particular example of this, component 121 can include parameters that represent some of the weights of the first layer, component 122 can include parameters that represent others of the weights of the first layer, while component 123 can include parameters that represent the biases of the first layer.

In some other cases, each component includes multiple layers of the neural network. Different components can include either the same or different types or numbers of neural network layers than one another. For example, in FIG. 1A, component 121 can include a first subset of layers of the neural network 110 while component 124 can include a second subset of layers of the neural network 110 that are arranged subsequent to the first subset of layers in the neural network 110.

In some other cases, each component includes a subset of the parameters of each of multiple layers of the neural network. For example, in FIG. 1A, component 121 can include, for each layer in a first subset of layers of the neural network 110, a subset of the parameters of the layer, while component 122 can include, for each layer in the first subset of layers of the neural network 110, another subset of the parameters of the layer. Thus, component 121 and component 122 can include different subsets of the parameters of a group of multiple layers.

This configuration of the neural network facilitates the composition of various paths through the neural network. Each path is composed of a sequence of multiple components. Each path represents an input-output function that maps a network input to a corresponding network output.

For example, each path can include multiple components that are selected from a larger number of components of the neural network and that are arranged in a sequential order one after the other, with the output of any component except the last being an input to another of the components. That is, each path can include a proper subset of all components of the neural network.

The composition of the sequences of components into paths by the distributed computing system 100 is dynamic. That is, different paths and, correspondingly, different components of the neural network 110 will be used to perform different machine learning tasks from the multiple machine learning tasks for which the neural network 110 can be used.

In some cases, different paths and, correspondingly, different components of the neural network 110 will be used to perform the same machine learning task, although two different paths may partially overlap, i.e., a common component may be included in paths for performing the same task.

For example, an image processing task may have a different path through the neural network 110 than an agent control task. As another example, when performing a data generation task (e.g., a text generation task, an image generation task, a video generation task, or an audio generation task) to generate an output sequence of tokens as the network output, a first plurality of tokens included in the output sequence may be generated by a different path through the neural network 110 than a second plurality of tokens included in the output sequence.

For a given network input 102 on which a given machine learning task will be performed, the distributed computing system 100 uses a router 105 to determine the one or more corresponding paths, i.e., can select which components to be included in each path of the one or more corresponding paths, and which other components to not be included in each path of the one or more corresponding paths, based on the network input 102.

The router 105 includes a set of routing parameters. The router 105 is configured to process at least a portion of the network input 102 in accordance with the set of routing parameters of the router 105 to generate a routing output that specifies a path through the neural network 110.

In practice the routing output can take many different forms. For example, the routing output can include a weight vector that includes a respective weight score for each of the possible paths through the neural network 110, i.e., for each different composition of a sequence of multiple components included in the neural network 110 that represents an input-output function that maps a network input to a corresponding network output. For example, in FIG. 1A, the routing output can include a weight vector that includes a respective weight score for each of the nine possible paths through the neural network 110.

In this example, the weight vector can be a sparse n-dimensional vector that includes non-zero weight scores for only a few of the possible paths through the neural network 110, and the router 105 selects only possible paths that have non-zero weights in the weight vector, e.g., by sampling a particular path from the possible paths in accordance with the weight scores included in the weight vector.

The number of non-zero weights may be an integer and may be very small in comparison with the total number of possible paths through the neural network 110. For example, the components included in the neural network 110 may be composed to form hundreds to thousands of possible paths through the neural network 110, and the weight vector may have fewer than fewer than ten, fewer than five, or fewer than two non-zero weight scores.

As another example, the routing output can include, for each of a plurality of “levels” within the neural network 110, a weight vector that includes a respective weight score for each component included in the level. For example, in FIG. 1A, there can be four levels—a first level which includes components 121, 122, 123, a second level which includes components 124, 125, 126, a third level which includes components 127, 128, 129, and a fourth level which includes components 130, 131, 132.

In this example, for each level, the weight vector can be a sparse n-dimensional vector that includes non-zero weight scores for only a few of the possible components included in the level, and the router 105 selects only components that have non-zero weights in the weight vector, e.g., by sampling a particular component from the components in accordance with the weight scores included in the weight vector. By selecting a particular component for each level, the router 105 can determine a path through the neural network 110 that is composed of the selected particular components.

FIG. 1B shows examples of selecting paths through an example neural network using the router 105.

As illustrated on the left hand side, in some cases, the distributed computing system 100 uses the router 105 to determine a single path for a network input (a “prefix”).

The router 105 processes at least a portion of the network input (i.e., at least a portion of the “prefix”) in accordance with the set of routing parameters of the router 105 to generate a routing output that specifies a path through the neural network 110. In FIG. 1B, the routing output identifies the second path π₂ from among the four possible paths π₁-π₄ through the neural network 110. Thus, after the second path π₂ is determined based on the network input, the second path π₂ will be used to generate a network output for the network input.

Although FIG. 1B illustrates the output as a training output generated during the training time of the neural network 110, this is not required. That is, the distributed computing system 100 can use the router 105 to determine a single path for a network input during inference time, too.

As illustrated on the right hand side, in other cases, the system uses the router 105 to determine multiple different paths for a network input (a “prefix”). For example, a given machine learning task to be performed on the network input can be a data generation task where the network output for the given machine learning task is an output sequence that includes a sequence of tokens.

The network output includes a plurality of portions-namely multiple “chucks”—where each portion includes a respective subset of the sequence of tokens included in the output sequence. In these cases, each different path will be used to generate a different portion of the network output, i.e., a different subset of the sequence of tokens included in the output sequence.

The router 105 process at least a portion of the network input (i.e., at least a portion of the “prefix”) in accordance with the set of routing parameters of the router 105 to generate a first weight vector that includes a respective weight score for each of the four possible paths π₁-π₄ through the neural network 110. After the first path π₁ is determined based on the network input, the first path 11 will be used to generate a first chunk of the network output for the network input.

Then, the router 105 process the first chuck of the network output in accordance with the set of routing parameters of the router 105 to generate a second weight vector that includes a respective weight score for each of the four possible paths π₁-π₄ through the neural network 110. After the fourth path 14 is determined based on the first chuck of the network output, the fourth path 14 will be used to generate a second chunk of the network output for the network input.

In either case discussed above, after having determined a path through the neural network 110, the neural network 110 will then use only the components in the determined path, i.e., and not using any of the components that are not in the determined path, to generate a network output 112 (or a portion of the network output 112) for a network input 102.

In this way, the neural network 110 is sparsely activated during inference. That is, during the processing of a network input 102 by the neural network 110, only a relatively small number of the parameters of the neural network 110 will be used to generate a corresponding network output 112. For example, while the neural network 110 includes 1 billion parameters, no more than 500 million, 250 million, or 100 million parameters that are included in the components included in a determined path through the neural network 110 will be used.

FIG. 1C shows an example path through the neural network 110.

In the example of FIG. 1C, the neural network 110 is configured to perform a machine learning task on a network input 102 to generate a network output 112. For example, the task can be a data generation task, where the network input 102 is an input sequence that includes a sequence of tokens selected from a vocabulary of tokens, and the output is an output sequence that includes another sequence of tokens selected from the vocabulary of tokens.

In this example, the vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

As part of performing the data generation task, each token included in the input sequence follows a path through the neural network 110.

In the example of FIG. 1C, the path for the data generation task is shown and components that are in the path are connected by arrows in the darker color while components that are not in the path are connected by arrows in the lighter color. Thus, as can be seen in the example, to perform the data generation task, the neural network 110 uses components 121, 124, 128, and 131 to process each token included in the input sequence. The remaining components 122, 123, 125, 126, 127, 129, 130, 132 of the neural network 110 that are not in the path are not used.

The components 121-132 of the neural network 110 are implemented across different workers included in the distributed computing system 100. A worker can include either a single computing device or multiple computing devices. Each computing device can include one or more processor cores, one or more processors, one or more microprocessors, special-purpose logic circuitry, and so on.

For example, each worker can include one or more central processing units (CPUs), one or more graphic processing units (GPUs), one or more field-programmable gate arrays (FPGAs), one or more application-specific integrated circuits (ASICs), such as one or more tensor processing units (TPUs), or some combination of these. As a particular example, a worker can include an island of a large number, e.g., hundreds or thousands, of interconnected TPUs. As another particular example, a worker can include one or more CPUs and one or more GPUs.

FIG. 1D shows example workers included in the distributed computing system 100.

The distributed computing system 100 includes a communication network 150 which interconnects the workers. Examples of the communication network 150 include a local area network (LAN), e.g., a data center network, and a wide area network (WAN), e.g., the Internet, to name just a few.

Each worker includes computational resources and storage resources. In some cases, each worker is substantially independent of other workers, e.g., the computational and storage resources of the workers are separate and distinct from one another, such that the multiple workers can operate in parallel.

In some cases, each worker implements an instance of each of one or more components of the neural network 110. For example, a worker can implement an instance of each of a respective subset of the plurality of components of the neural network 110 that are included in a same path through the neural network 110. In some cases, because different paths may overlap, i.e., a common component may be included in the multiple paths, a different local instance of the same component can be implemented on each of multiple workers.

For example, as shown in FIG. 1C, there are a total of four different paths π₁-π₄ through a neural network, where the worker 152 in the distributed computing system 100 implements local instances of components included in path 11; the worker 162 in the distributed computing system 100 implements local instances of components included in path π₂; the worker 172 in the distributed computing system 100 implements local instances of components included in path 113; and the worker 182 in the distributed computing system 100 implements local instances of components included in path π₄. In FIG. 1D, assuming the four different paths π₁-π₄ include a common component, then each of the workers 152, 162, 172, 182 can implement a respective local instance of the common component.

In some cases, the distributed computing system 100 includes homogeneous computing devices. That is, the worker are all the same type of worker. However, in other cases, the distributed computing system 100 includes heterogeneous computing devices. That is, the distributed computing system 100 includes two or more different types of computing devices.

For example, as shown in FIG. 1D, the worker 152 in the distributed computing system 100 can include one or more GPUs, the worker 162 in the distributed computing system 100 can include one or more CPUs, while the workers 172, 182 in the distributed computing system 100 can each include one or more TPUs.

More generally, the heterogeneity of the computing devices of the distributed computing system 100 may arise from the computing devices having different hardware capabilities, e.g., having different hardware versions or being manufactured by differing hardware manufacturers.

In some cases, the plurality of workers are located in the same physical location, e.g., in a data center that houses the multiple computing devices. In some of these cases, the plurality of computing devices are run by a single organization.

However, in other cases, the plurality of workers are physically or geographically remote from each other. For example, as shown in FIG. 1C, workers 152, 162, 172, and 182 are in different cities, different states, different countries, and even different continents. In some of these other cases, the plurality of workers are run by multiple organizations, e.g., by a community of organizations.

To facilitate the training of the neural network, each worker maintains training data by utilizing the storage resources. The training data includes a set of training inputs and, optionally, in some cases, for each training input, a respective target output that should be generated by the neural network 110 to perform the particular task.

In some cases, the distributed computing system 100 obtains a training dataset and partitions the training dataset into a plurality of shards for storage at each of the plurality of workers. Thus, each worker stores a local shard of the training dataset.

In some cases, the local shards of the training dataset maintained at the plurality of workers have about equal size as each other, whereas, in other cases, the sizes of the local shards of the training dataset vary from one worker to another. For example, a worker having more storage resources, and thus having greater storage capability, than another worker can store a larger local shard of the training dataset that includes a larger number of training inputs than the other worker.

In some cases, the local shards of the training dataset maintained at the plurality of workers include different training inputs than each other, whereas, in other cases, the local shards of the training dataset maintained at two or more of the plurality of workers include at least a same training input.

For example, as shown in FIG. 1D, worker 152 maintains a first local shard 154 of the training dataset, worker 162 maintains a second local shard 164 of the training dataset, worker 172 maintains a third local shard 174 of the training dataset, and worker 182 maintains a fourth local shard 184 of the training dataset.

There are many ways in which the training dataset can be partitioned after it has been obtained by the distributed computing system 100. For example, the distributed computing system 100 can assign each of a plurality of training inputs included in the training dataset into one of k shards based on applying a k-means assignment algorithm to at least a portion of the training input.

The “k-means” assignment algorithm is an unsupervised algorithm of assigning data into k clusters, where k is equal to the number of workers or the number of islands of workers. It is an iterative algorithm in which a single iteration consists of two phases:
1-Assignment phase: Each training input included in the training dataset is assigned to one of the k clusters that is the closest in terms of a distance measure, e.g., a Euclidean distance or a cosine distance, between at least a portion of the training input and the centroid of the cluster;
2-Update phase: Update all k cluster centroids by computing the arithmetic mean of each cluster.

The assignment phase and the update phase iterations are then repeated until a final assignment of the training inputs is accomplished.

As another example, the distributed computing system 100 can assign each of the plurality of training inputs included in the training dataset into one of the k shards based on processing at least a portion of the training input using a classification machine learning model. Examples of the classification machine learning mode include a logistic regression model, a neural network, a support vector machine, and a random forest model, to name just a few.

For each training input, the classification machine learning model processes at least a portion of the training input to generate a classification output that classifies the training input into one of the k shards. For example, the classification output can include scores for each of the k shards, with each score representing a likelihood that the training input belongs to the shard.

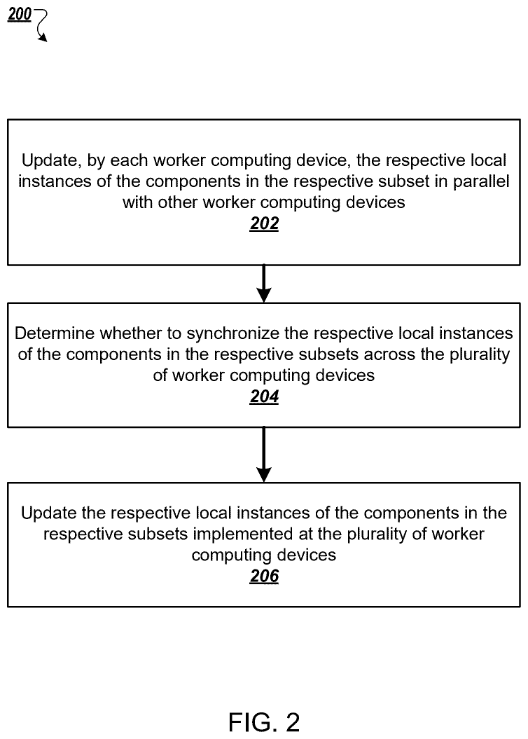

FIG. 2 is a flow diagram of an example process 200 for training a neural network on a training dataset. For convenience, the process 200 will be described as being performed by a system of one or more computers located in one or more locations. For example, a distributed computing system, e.g., the distributed computing system 100 of FIG. 1A, appropriately programmed, can perform the process 200.

The neural network includes a plurality of components. Each component includes a respective, non-overlapping subset of a plurality of parameters of the neural network. This configuration of the neural network facilitates the composition of a plurality of paths through the neural network.

Each path is composed of a respective subset of the plurality of components of the neural network. Each path represents an input-output function that maps a network input to a corresponding network output. An example of a path through the neural network 110, which includes components 121, 124, 128, and 131 of neural network 110, is shown in FIG. 1A.

Thus, the respective subset of the plurality of components include in a path include at least a respective input component of the neural network that receives the network input (or a portion of the network input) to the neural network and a respective output component of the neural network that generates the network output of the neural network (or a portion of the network output). Examples of the respective input components include components 121, 122, and 123 in FIG. 1A. Examples of the respective output component include components 130, 131, and 132 in FIG. 1A.

The distributed computing system includes a plurality of workers. The plurality of workers correspond to the plurality of paths through the neural network. That is, for a given path of the plurality of paths that includes a given subset of the plurality of components of the neural network, a corresponding worker can implement a respective local instance of each component in the given subset.

The system updates, by each worker, the respective local instances of the components in the corresponding path in parallel with independently of other workers (step 202). In effect, each worker updates, in parallel with and independently of the other workers, a respective local instance of each of a respective subset of the plurality of components that are included in the path that corresponds to the worker.

Each worker can train the respective local instances of the components in the respective subset by performing a plurality of inner optimization steps using training inputs obtained from a local shard of the training dataset that is stored at the worker.

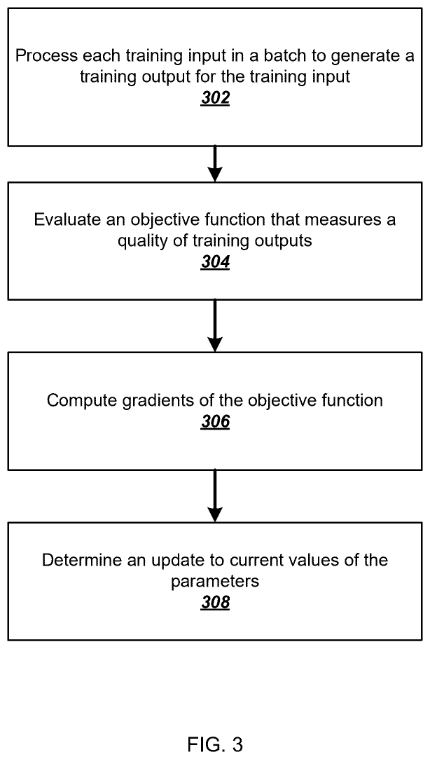

An inner optimization step is described below with reference to FIG. 3, which shows a flow diagram of sub-steps 302-308 of step 202. The system can repeatedly perform iterations of steps 302-308 at each worker to repeatedly perform multiple inner optimization steps to train the respective local instances of the components in the respective subset.

The system obtains a batch of training inputs and, for each training input in the batch, processes the training input in accordance with parameters of the respective local instance of each component in the respective subset to generate a training output for the training input (step 302). The system can obtain the batch of training inputs using any suitable way, e.g., through sampling, The system refrains from using any other components of the neural network that are not in the respective subset, i.e., that are not included in the path corresponding to the worker, to process the training inputs.

The system evaluates an objective function that measures a quality of the training outputs generated for the batch of training inputs (step 304). The objective function can be any appropriate differentiable objective function that is appropriate for the training data, i.e., that measures the quality of a training output generated by the neural network for a given training input, e.g., relative to a target output for the given training input. Examples of the objective function include a cross-entropy loss function, a squared error loss function, a negative log likelihood loss function, and so on.

The system computes gradients of the objective function with respect to the parameters included in the respective local instance of each component in the respective subset (step 306). The system can compute the gradients using a gradient-based training technique, e.g., through backpropagation.

The system determines an update to current values of the parameters of the local instance of each component in the respective subset based on applying an optimizer to the gradients (step 308). Examples of the optimizer include an Adam optimizer, an AdamW optimizer, an Adafactor optimizer, a rmsProp optimizer, a stochastic gradient descent optimizer, and so on.

In some cases, the system performs path-specific early stopping by using a smaller number of training inputs that are set aside and that are not used during the inner optimization steps. The system determines, at each worker, whether to apply early stopping based on a quality of training outputs generated from the set aside training inputs in accordance with parameters of the respective local instances of the components in the respective subset. For example, the system can early stop the training of the respective local instances of the components in a particular path corresponding to a particular worker when the quality that is determined based on evaluating the objective function over the set aside training inputs satisfies a quality threshold, i.e., while the training of the components of the neural network at other workers continues.

In practice, data transmission between the workers through the communication network is expensive, e.g., in terms of time, resource usage, or power usage. For one, performance of the communication network may be poor, e.g., the connections between two or more of the workers may not be established in the first try (and thus multiple re-tries become necessary) and/or may be lost. For another, the physical distance between these multiple working computing devices is long.

Therefore, when performing the plurality of inner optimization steps as part of step 202 to update the local instance of each component in the respective subset at each worker, the plurality of workers need not, and in some cases do not, communicate with each other over a communication network that connects the plurality of workers. By not communicating with each other after every inner optimization step during step 202, the system reduces the amount of communication needed during the training of the neural network.

Because two different workers train a same component that is included in two different paths on different training data, at a result of the inner optimization steps performed independently at each worker, different local instances of the same component of the neural network implemented at different workers will have different parameter values than each other.

The system determines whether to synchronize the respective local instances of the components in the respective subsets across the plurality of workers (step 204). Such a determination can be made at any time while step 202 is being performed.

For example, the system can keep a count of the number of inner optimization steps that have been performed at each worker (during the current iteration of process 200) and, when the counted number reaches a predetermined number, determine that the respective local instances of the components in the respective subsets across the plurality of workers should be synchronized.

As another example, the system can keep a count of an amount of time that has elapsed since the first inner optimization step has been performed at each worker (during the current iteration of process 200) and, when the counted amount of time reaches a predetermined amount, determine that the respective local instances of the components in the respective subsets across the plurality of workers should be synchronized.

In response to determining to synchronize, the system performs an outer optimization step to update the respective local instances of the components in the respective subsets implemented at the plurality of workers (step 206), such that different local instances of the same component of the neural network implemented at the different workers have the same values as each other. In practice the outer optimization steps can be performed at a much lower frequency than the inner optimization steps. For example, each iteration of the process 200 may involve one hundred, two hundreds, five hundreds, or more inner optimization steps for each worker, while involving only one outer optimization step for each component.

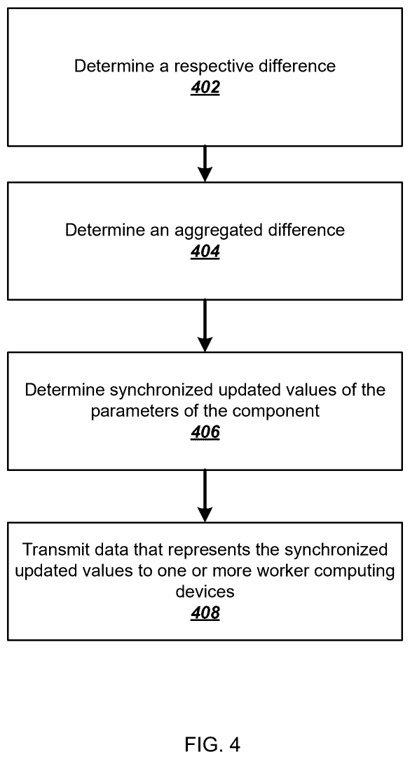

An outer optimization step is described below with reference to FIG. 4, which shows a flow diagram of sub-steps 402-408 of step 206. By performing an iteration of steps 402-406 for each of the plurality of components of the neural network, the system can perform the outer optimization step.

The system determines, at each of one or more workers that maintain a respective local instance of the component, a respective difference between (i) previous values of parameters of the respective local instance of the component prior to step 202 (in the current iteration of process 200), e.g., prior to the predetermined number of inner optimization steps, and (ii) updated values of the parameters of the respective local instance of the component after step 202 (in the current iteration of process 200), e.g., after the predetermined number of inner optimization steps (step 402).

The system determines an aggregated difference from the respective differences determined for the one or more workers (step 404). The aggregated difference can be determined in many different ways, e.g., as a weighted or unweighted sum or average of the respective differences.

As a particular example, the system can determine the aggregated difference by computing a weighted average of the respective differences determined for the one or more workers, where the respective difference determined for each of the one or more workers is weighted by a number of training inputs included in the shard maintained by the worker. In this way the respective difference for a worker that maintains a larger number of training inputs will be assigned a greater weight than the respective difference for another worker that maintains a smaller number of training inputs.

In some cases, the system can apply norm rescaling to the aggregated difference, and use the norm rescaled aggregated difference as the aggregated difference. Norm rescaling accounts for the variation in the numbers of paths that each component may belong to. For example, the system can scale a norm of the aggregated difference by a function, e.g., a square root, a division, or an inverse, of the number of workers that each maintain a respective local instance of the component.

In some cases, the system can apply loss reweighting to the aggregated difference, and use the loss reweighted aggregated difference as the aggregated difference. Loss reweighting accounts for the variation in the sizes of the local shards of the training data that are maintained across the plurality of workers; for example it can account for the over-sampling of a local shard that has a smaller size. For example, the system can weigh the aggregated difference in proportion to the size of the local shard maintained at each worker by computing the following equations (where the definition of the symbols is consistent with the definition provided in Algorithm 1 further below):

$$\text{?} ← \sum \text{?} ( \text{?} - \text{?} ) ,$$

$$with :$$

$$\text{?} = \frac{\vert \text{?} \vert}{\sum \vert \text{?} \vert} .$$

$$\text{?} \text{indicates text missing or illegible when filed}$$

In some cases, the system can apply both norm rescaling and loss reweighting to the aggregated difference, and use the norm rescaled and loss reweighted aggregated difference as the aggregated difference.

The system determines synchronized updated values of the parameters of the component based on applying an optimizer to the aggregated difference (step 406). Examples of the optimizer include a Nesterov momentum optimizer, an Adam optimizer, an AdamW optimizer, an Adafactor optimizer, a rmsProp optimizer, a stochastic gradient descent optimizer, and so on.

In some cases, the optimizer applied in the inner optimization steps is the same as the optimizer applied in the outer optimization steps, whereas, in other cases, the optimizer applied in the inner optimization steps is different from the optimizer applied in the outer optimization steps. As a particular example, the system applies an AdamW optimizer in the inner optimization steps, and applies a Nesterov momentum optimizer in the outer optimization steps.

The system transmits data that represents the synchronized updated values of the parameters of the component to the one or more workers (step 408), such that each of the one or more workers can update the respective local instance of the component implemented on the worker to have the same, synchronized updated values.

By repeatedly performing iterations of process 200, the system can train the neural network on the training dataset to update the values of parameters included in each respective subset of the plurality of components of the neural network—and hence the values of all of the plurality of parameters of the neural network—across the plurality of workers by using the local shard of the training dataset maintained at each worker.

An example algorithm for training the neural network on the training dataset is shown below.

Algorithm 1 DiPaCo

Require: Num. levels L, num. experts per level Kᵢ, paths πᵢ with i ϵ 1, . . . , P and
$P = {\prod }_{i = 1}^{\text{?}} {K}_{i} . Let {P}_{\text{?}}$
be the number of paths going through module e at level l.
Require: Pre-sharded training set into ( [symbol] ₗ, ... , [symbol] ₚ)
Require: Parameters of pretrained model used for initialization: [symbol] ,
${θ}_{\text{?}}^{\text{?}} = {θ}^{\text{?}} ,$ i ϵ 1, . . . , P.
Require: Optimizers ImmerOpt and OuterOpt

| 1: | for outer step t = 1 . . . T do | | |
|---|---|---|---|
| 2: | (Optional, in this work done once during training) discriminatively re-shard data | | |
| 3: | for worker i = 1. . . P do | | |
| 4: | ${θ}_{\text{?}}^{\text{?}} = {θ}_{\text{?}}^{\text{?}}$ | | |
| 5: | for inner step n = l . . . τ do | | |
| 6: | x ~ [symbol] ᵢ | {close oversize brace} | Inner Optimization: parallel per path |
| 7: | [symbol] ← f(x, [symbol] ) | | |
| 8: | ${θ}_{\text{?}}^{\text{?}} ← InnerOpt ( {θ}_{\text{?}}^{\text{?}} , {∇}_{\text{?}} )$ | | |
| 9: | end for | | |
| 10: | end for | | |
| 11: | for level l = 1 . . . L do | | |
| 12: | for expert e = 1 . . . K [symbol] do | | |
| 13: | ${Δ ( i , e )}^{\text{?}} ← \frac{1}{{P}_{\text{?}}} {\sum }_{\text{?}}^{\text{?}} ( {θ ( l , e )}^{\text{?}} - {θ ( i , e )}_{\text{?}}^{\text{?}} )$ | {close oversize brace} | Outer Optimization: parallel per module |
| 14: | θ(l, e)^{t} ← OuterOpt(θ(l, e)^{t-1}, Δ(l, e)^{t}) | | |
| 15: | end for | | |

| | |
|---|---|
| 16: | end for |
| 17: | end for |

[symbol]

indicates data missing or illegible when filed

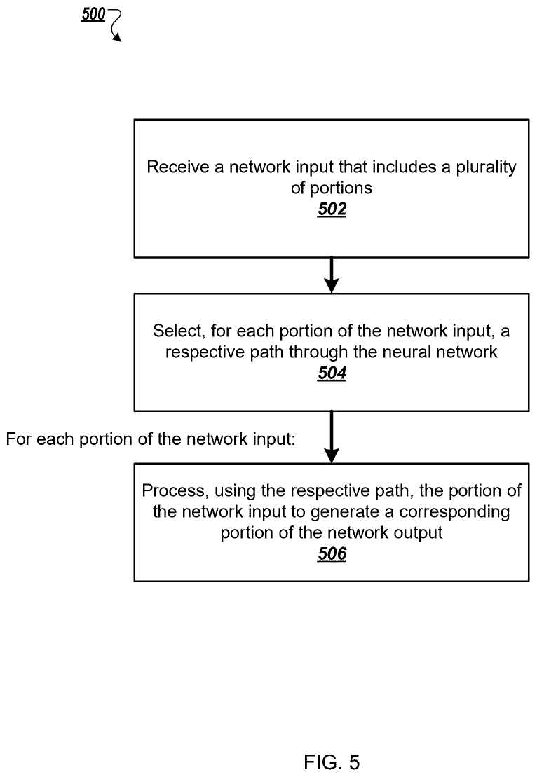

FIG. 5 is a flow diagram of an example process 500 for using a neural network to generate a network output from a network input. For convenience, the process 500 will be described as being performed by a system of one or more computers located in one or more locations. For example, a distributed computing system, e.g., the distributed computing system 100 of FIG. 1A, appropriately programmed, can perform the process 500.

The neural network includes a plurality of components. The system includes a plurality of workers. The plurality of components are implemented at different workers.

The system receives a network input to be processed by a neural network to generate a network output (step 502). The network output includes a plurality of portions. For example, the network output can be an output sequence that includes a sequence of tokens, where each portion includes a respective subset of the sequence of tokens included in the output sequence.

The system selects, for each portion of the network output, a respective path through the neural network from a plurality of paths through the neural network (step 504). Each path includes a respective proper subset of the plurality of components. The respective proper subset of the plurality of components includes at least a respective input component and a respective output component. In some cases, the same path is selected for the plurality of portions of the network output, whereas, in other cases, different paths are selected for the plurality of portions of the network output.

For each portion of the network output, the respective path through the neural network can be selected by the system based on processing either a portion of the network input or a portion of the network output using a router. For example, the portion of the network output that is processed by the router to select the respective path can be an immediately preceding portion of the network output that has been generated by a previously selected path through the neural network and that precedes the portion of the network output. If the portion of the network output is the beginning portion of the network output, because there is no preceding portion, the router can instead process at least a portion of the network input to select the respective path.

For each portion of the network output, the system generates, using the respective proper subset of the plurality of components included in the respective path, the portion of the network output (step 506). For example, the portion of the network output can be generated by the system based on processing (i) network input, (ii) one or more immediately preceding portions of the network output that have already been generated, or both (i) and (ii) using the respective subset of the plurality of components included in the respective path.

In particular, the neural network uses only the components of the neural networks that are in the respective proper subset included in the respective path, i.e., not any of the remaining, unselected components that are excluded from the respective path, and thus are not included in the respective proper subset, to generate each portion of the network output.

Thus, the network output can be an output sequence that includes a sequence of tokens that are generated by using a smaller subset of all parameters of the neural network. Further, when different paths are selected for the plurality of portions of the network output, the network output can be an output sequence that includes a sequence of tokens that are generated by different paths—and hence different combination of components—of the neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of training a neural network on a training dataset using a distributed computing system comprising a plurality of workers, wherein the method comprises:
maintaining, at each of the plurality of workers, a respective local instance of each component in a respective subset of a plurality of components of the neural network that represents a path through the neural network, wherein each component of the neural network comprises a different subset of the plurality of parameters of the neural network, and wherein the respective subset of the plurality of components that represents the path through the neural network comprise at least an input component of the neural network that receives an input to the neural network and an output component of the neural network that generates an output of the neural network;
updating, by each worker, the respective local instances of the components in the respective subset in parallel with other workers;
determining whether to synchronize the respective local instances of the components in the respective subsets across the plurality of workers; and
in response to determining to synchronize, updating the respective local instances of the components in the respective subsets implemented at the plurality of workers.

2. The method of claim 1, wherein updating, by each worker, the local instance of each component of the neural network in the respective subset comprises:
maintaining a local shard of a training dataset; and
updating the respective local instances of components in the respective subset based on the local shard of the training dataset.

3. The method of claim 1, wherein updating, by each worker, the local instance of each component of the neural network in the respective subset comprises:
assigning each of a plurality of training inputs included in the training dataset into one of k shards based on applying a k-means assignment algorithm to at least a portion of the training input.

4. The method of claim 1, wherein updating, by each worker, the local instance of each component of the neural network in the respective subset comprises:
assigning each of the plurality of training inputs included in the training dataset into one of the k shards based on processing at least a portion of the training input using a logistic regression classifier.

5. The method of claim 2, wherein the local shards of the training dataset maintained at the plurality of workers include different training inputs than each other.

6. The method of claim 2, wherein the local shards of the training dataset maintained at two or more of the plurality of workers include at least a same training input.

7. The method of claim 1, wherein updating, by each worker, the local instance of each component of the neural network in the respective subset comprises, at each of a plurality of inner optimization steps:
evaluating an objective function that measures a quality of training outputs generated in accordance with parameters of the respective local instance of each component in the respective subset;
computing gradients of the objective function with respect to the respective local instance of each component in the respective subset; and
determining an update to current values of the parameters of the respective local instance of each component in the respective subset based on applying an AdamW optimizer to the gradients.

8. The method of claim 7, wherein determining whether to synchronize the respective local instances of the components of the neural network in the respective subsets across the plurality of workers comprises:
determining whether a predetermined number of inner optimization steps have been performed to update the respective local instance of each component of the neural network in the respective subset by each worker.

9. The method of claim 1, wherein updating the local instances of the components of the neural network in the respective subsets implemented at the plurality of workers comprises, for each of the plurality of components of the neural network:
determining, at each of one or more workers that maintain a respective local instance of the component, a respective difference between (i) previous values of parameters of the respective local instance of the component prior to the predetermined number of inner optimization steps and (ii) updated values of the parameters of the local instance of the component after the predetermined number of inner optimization steps;
determining an aggregated difference from the respective differences determined for the one or more workers;
determining synchronized updated values of the parameters of the component based on applying a Nesterov momentum optimizer to the aggregated difference; and
transmitting data that represents the synchronized updated values of the parameters of the component to the one or more workers.

10. The method of claim 9, wherein determining the aggregated difference comprises determining a weighted average of the respective differences determined for the one or more workers where the respective difference determined for each of the one or more workers is weighted by a number of training inputs included in the shard maintained by the worker.

11. The method of claim 9, wherein determining the aggregated difference comprises scaling a norm of the aggregated difference by a square root of a number of workers that each maintain a respective local instance of the component.

12. The method of claim 1, wherein updating, by each worker, the local instance of each component of the neural network in the respective subset comprises:
determining, by each worker, whether to apply early stopping based on a quality of training outputs generated from one or more training inputs in accordance with parameters of the respective local instances of the components in the respective subset.

13. The method of claim 1, wherein the neural network comprises a Transformer neural network.

14. The method of claim 1, wherein the neural network comprises a large language model (LLM) or a visual language model (VLM) neural network.

15. The method of claim 1, wherein the plurality of workers comprise two or more different types of computing devices.

16. The method of claim 1, wherein the plurality of workers are physically or geographically or both remote from each other.

17. The method of claim 1, wherein, when updating the local instance of each component of the neural network in the respective subset, the plurality of workers do not communicate with each other over a communication network that connects the plurality of workers.

18. A method performed by one or more computers, the method comprising:
receiving a network input to be processed by a neural network to generate a network output for a machine learning task, the neural network comprising a plurality of components, the plurality of components implemented at different workers, and the network output comprising a plurality of portions;
selecting, for each portion of the network output, a respective path through the neural network from a plurality of paths through the neural network, each path comprising a respective proper subset of the plurality of components, the respective proper subset comprising at least a respective input component and a respective output component;
for each portion of the network output: generating, using only the respective proper subset of the plurality of components included in the respective path, the portion of the network output.

19. The method of claim 18, wherein selecting, for each portion of the network output, the respective path through the neural network comprises selecting the respective path based on processing either a portion of the network input or a portion of the network output using a router.

20. A system comprising one or more computers and one or more storage devices storing instructions that when executed by the one or more computers cause the one more computers to perform operations for training a neural network on a training dataset using a distributed computing system comprising a plurality of workers, wherein the operations comprise:
maintaining, at each of the plurality of workers, a respective local instance of each component in a respective subset of a plurality of components of the neural network that represents a path through the neural network, wherein each component of the neural network comprises a different subset of the plurality of parameters of the neural network, and wherein the respective subset of the plurality of components that represents the path through the neural network comprise at least an input component of the neural network that receives an input to the neural network and an output component of the neural network that generates an output of the neural network;
updating, by each worker, the respective local instances of the components in the respective subset in parallel with other workers;
determining whether to synchronize the respective local instances of the components in the respective subsets across the plurality of workers; and
in response to determining to synchronize, updating the respective local instances of the components in the respective subsets implemented at the plurality of workers.

21. One or more non-transitory computer storage media storing instructions that when executed by one or more computers cause the one more computers to perform the operations for training a neural network on a training dataset using a distributed computing system comprising a plurality of workers, wherein the operations comprise:
maintaining, at each of the plurality of workers, a respective local instance of each component in a respective subset of a plurality of components of the neural network that represents a path through the neural network, wherein each component of the neural network comprises a different subset of the plurality of parameters of the neural network, and wherein the respective subset of the plurality of components that represents the path through the neural network comprise at least an input component of the neural network that receives an input to the neural network and an output component of the neural network that generates an output of the neural network;
updating, by each worker, the respective local instances of the components in the respective subset in parallel with other workers;
determining whether to synchronize the respective local instances of the components in the respective subsets across the plurality of workers; and
in response to determining to synchronize, updating the respective local instances of the components in the respective subsets implemented at the plurality of workers.
